(19) United States
(12) Patent Application Publication
(10) Pub. No.: US 2017/0039918 A1
(43) Pub. Date: Feb. 9, 2017

(54) DISPLAY PANEL

(71) Applicant: Chunghwa Picture Tubes, LTD., Taoyuan City (TW)

(72) Inventors: Fu-Hsiang Tsao, Hsinchu County (TW); Jhen-Shen Liao, Taoyuan City (TW); Hung-Hsiang Chen, Taoyuan City (TW); De-Wei Kuo, Taipei City (TW)

(21) Appl. No.: 14/819,932

(22) Filed: Aug. 6, 2015

(51) Int. Cl. G09G 3/20

(52) U.S. Cl. CPC G09G 3/2003; G09G 2300/0452; G09G 2330/023

(57) ABSTRACT

A display panel is provided. The display panel includes a plurality of data lines and a sub-pixel array. The sub-pixel array includes a plurality of pixel units. The pixel units are arranged along a first direction or a second direction, the first direction is inclined at a first angle relative to a column direction, and the second direction is inclined at a second angle relative to the column direction. Each of the pixel units includes a plurality of sub-pixels respectively corresponding to three different colors and adjacently arranged in a row direction. Each of the data lines is coupled to a first sub-pixel unit at a side of the data line along the column direction and a second sub-pixel unit at another side of the data line along the column direction. The first sub-pixel unit and the second sub-pixel unit are located in different rows.

### BACKGROUND OF THE INVENTION

1. Field of the Invention

The present invention relates to flat display technology, in particular, to a display panel that may achieve both lower power consumption and good display quality.

2. Description of Related Art

With progress of display technology, pixel and driving circuit have been developed to satisfy demands for high resolution and low power consumption of mobile devices. Since how to improve display effects of display panels has gradually become a significant issue for the display panel manufactures, a sub-pixel rendering (SPR) technology has come into being for overcoming fabrication limitations and achieving good display quality.

FIG. 1A is a schematic diagram illustrating a conventional display apparatus, and FIG. 1B is a schematic diagram illustrating a top view of a part of a display panel of the display apparatus in FIG. 1A. Referring to FIG. 1A first, a conventional display apparatus 100 includes a gate driver 110, a source driver 120, and a display panel 130. The display panel 130 includes n×m sub-pixels (e.g. sub-pixels P1 to P4) arranged in an array, where n and m are positive integers. The sub-pixels may respectively correspond to color pixels, such as red pixels, green pixels and blue pixels (respectively notated by R, G and B). In addition, scan lines SL1 to SLn are respectively electrically connected to an output terminal of the gate driver 110, and data lines DL1 to DLm are respectively electrically connected to an output terminal of the source driver 120.

Referring to FIG. 1B, a part of the display panel 130 (e.g. a sub-pixel array including 12×6 sub-pixels with scan lines SL1 to SL12 and data lines DL1 to DL6) of the display apparatus 100 is illustrated in detail. By using the SPR technology, sub-pixels corresponding to a same color (e.g. red, green or blue) may be arranged in a zigzag shape within each three columns of the sub-pixel array. In addition, current technology may generally arrange the data lines (e.g. data lines DL1 to DL6 in FIG. 1B) in a stripe shape for being coupled to the sub-pixels R, G and B.

However, the aforementioned arrangements of the sub-pixels and the data lines may cause additional power cost, particularly disadvantageous in a situation of displaying a full-screen image frame with a solid color, since the sub-pixels coupled to each of the data lines may respectively correspond to different colors along a column direction (e.g. the sub-pixels R, B, G and B are sequentially coupled to the data line DL1 along the column direction). For instance, when the display panel 130 is driven to display a full-screen image frame with a red color, a voltage transmitted on each of the data lines may be toggled between different voltage levels frequently for charging the sub-pixels R while discharging the sub-pixels G and B along the column direction, and thus a power consumption may be increased. Hence, how to design a display panel that is capable of overcoming the above problem is an important issue that needs to be solved.

### SUMMARY OF THE INVENTION

Accordingly, the present invention is directed to a display panel, which is capable of reducing the power consumption resulting from the toggling voltage transmitted on each of the data lines.

The invention provides a display panel including a plurality of data lines and a sub-pixel array. The sub-pixel array includes a plurality of pixel units. The pixel units are arranged along a first direction or along a second direction, the first direction is inclined at a first angle relative to a column direction of the sub-pixel array, and the second direction is inclined at a second angle relative to the column direction of the sub-pixel array. Each of the pixel units includes a plurality of sub-pixels, and the sub-pixels respectively correspond to three different colors and are adjacently arranged in a row direction of the sub-pixel array. Each of the data lines is coupled to a first sub-pixel unit at a side of the each of the data lines along the column direction of the sub-pixel array, and is coupled to a second sub-pixel unit at another side of the each of the data lines along the column direction of the sub-pixel array. The first sub-pixel unit includes at least one first sub-pixel, and the second sub-pixel unit includes at least one second sub-pixel. The first sub-pixel unit and the second sub-pixel unit are located in different rows.

In an embodiment of the invention, each of the data lines is coupled to a plurality of repeat units, the repeat units are repeatedly arranged along the column direction, and each of the repeat units includes the first sub-pixel unit and the second sub-pixel unit.

In an embodiment of the invention, the at least one first sub-pixel corresponds to two of the three colors, and the at least one second sub-pixel corresponds to at least one of the corresponding two colors of the at least one first sub-pixel.

In an embodiment of the invention, the first sub-pixel unit includes one first sub-pixel, and the second sub-pixel unit includes one second sub-pixel.

In an embodiment of the invention, the one first sub-pixel corresponds to two of the three colors along the column direction, and the one second sub-pixel corresponds to one of the corresponding two colors of the one first sub-pixel.

In an embodiment of the invention, the sub-pixel array is divided into a plurality of display regions, and each of the display regions has four rows. In each of the display regions, a pixel unit in a first row, a pixel unit in a second row and a pixel unit in a third row are arranged along the first direction, and the pixel unit in the third row in the display region and a pixel unit in a fourth row of the display region are arranged along the second direction.

In an embodiment of the invention, the one first sub-pixel corresponds to two of the three colors along the column direction, and the one second sub-pixel corresponds to the corresponding two colors of the one first sub-pixel.

In an embodiment of the invention, the sub-pixel array is divided into a plurality of display regions, and each of the display regions has six rows. In each of the display regions, a pixel unit in a first row, a pixel unit in a second row, a pixel unit in a third row and a pixel unit in a fourth row are arranged along the first direction, and the pixel unit in the fourth row, a pixel unit in a fifth row and a pixel unit in the sixth row are arranged along the second direction.

In an embodiment of the invention, the first sub-pixel unit includes two first sub-pixels, and the second sub-pixel unit includes two second sub-pixels.

In an embodiment of the invention, the two first sub-pixels respectively correspond to two different colors of the three colors, and the two second sub-pixels respectively correspond to the corresponding two different colors of the two first sub-pixels.

In an embodiment of the invention, the sub-pixel array is divided into a plurality of display regions, and each of the display regions has four rows. In each of the display regions, a pixel unit in a first row, a pixel unit in a second row and a pixel unit in a third row are arranged along the first direction, and the pixel unit in the third row and a pixel unit in a fourth row are arranged along the second direction.

In an embodiment of the invention, the first sub-pixel unit includes two first sub-pixels, and the second sub-pixel unit includes one second sub-pixel.

In an embodiment of the invention, the two first sub-pixels respectively correspond to two different colors of the three colors, and the one second sub-pixel corresponds to one of the corresponding two colors of the one first sub-pixel.

In an embodiment of the invention, the sub-pixel array is divided into a plurality of display regions, and each of the display regions has three rows. In each of the display regions, a pixel unit in a first row, a pixel unit in a second row and a pixel unit in a third row are arranged along the first direction.

In an embodiment of the invention, sub-pixels corresponding to a same color are not adjacent to each other along the column direction of the sub-pixel array, and the sub-pixels corresponding to the same color are not adjacent to each other along the row direction of the sub-pixel array, wherein the same color is one of the three colors.

In an embodiment of the invention, the first direction and the second direction are not parallel.

In an embodiment of the invention, the sub-pixels are red sub-pixels, green sub-pixels and blue sub-pixels.

Based on the above, the display panel disclosed by the embodiments of the invention may provide multiple arrangements of the sub-pixels and the data lines respectively, which may adaptively arrange the sub-pixels corresponding to a same color to be coupled to only a portion of the data lines. Therefore, in the situation that a full-screen image frame with a solid color is required to be displayed, a frequency of the toggling voltage transmitted on each of the data lines may be decreased, and the power consumption may be effectively reduced accordingly.

### BRIEF DESCRIPTION OF THE DRAWINGS

FIG. 1A is a schematic diagram illustrating a conventional display apparatus.

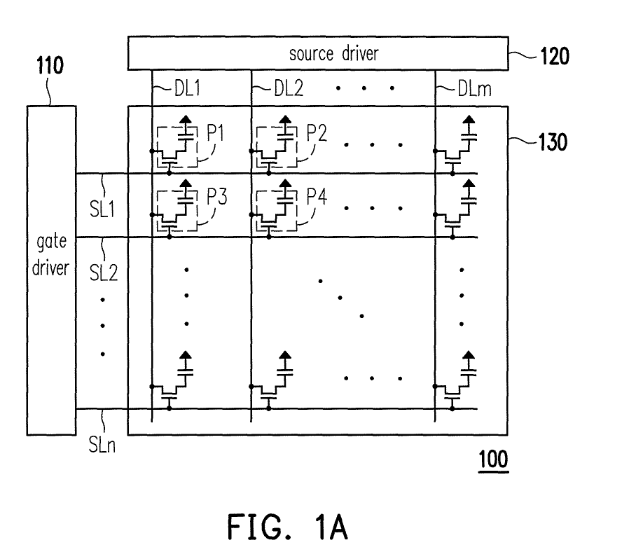

FIG. 1B is a schematic diagram illustrating a top view of a part of a display panel of the conventional display apparatus in FIG. 1A.

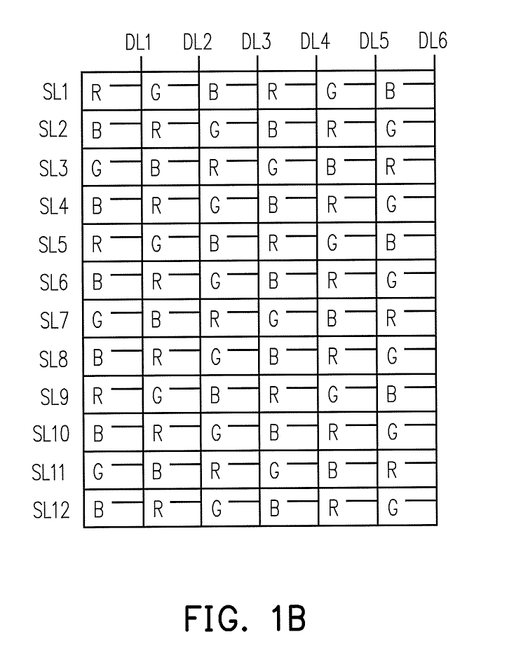

FIG. 2A is a schematic diagram illustrating a top view of a display panel according to an embodiment of the invention.

FIG. 2B is a schematic diagram illustrating a top view of a sub-pixel array of the display panel according to the embodiment of FIG. 2A.

FIG. 2C is a schematic diagram illustrating an arrangement of a data line of the display panel according to the embodiment of FIG. 2A.

FIG. 3A is a schematic diagram illustrating a top view of a display panel according to another embodiment of the invention.

FIG. 3B is a schematic diagram illustrating an arrangement of a data line of the display panel according to the embodiment of FIG. 3A.

FIG. 4A is a schematic diagram illustrating a top view of a display panel according to another embodiment of the invention.

FIG. 4B is a schematic diagram illustrating a top view of a sub-pixel array of the display panel according to the embodiment of FIG. 4A.

FIG. 5A is a schematic diagram illustrating a top view of a display panel according to another embodiment of the invention.

FIG. 5B is a schematic diagram illustrating a top view of a sub-pixel array of the display panel according to the embodiment of FIG. 5A.

FIG. 5C is a schematic diagram illustrating an arrangement of a data line of the display panel according to the embodiment of FIG. 5A.

### DESCRIPTION OF THE EMBODIMENTS

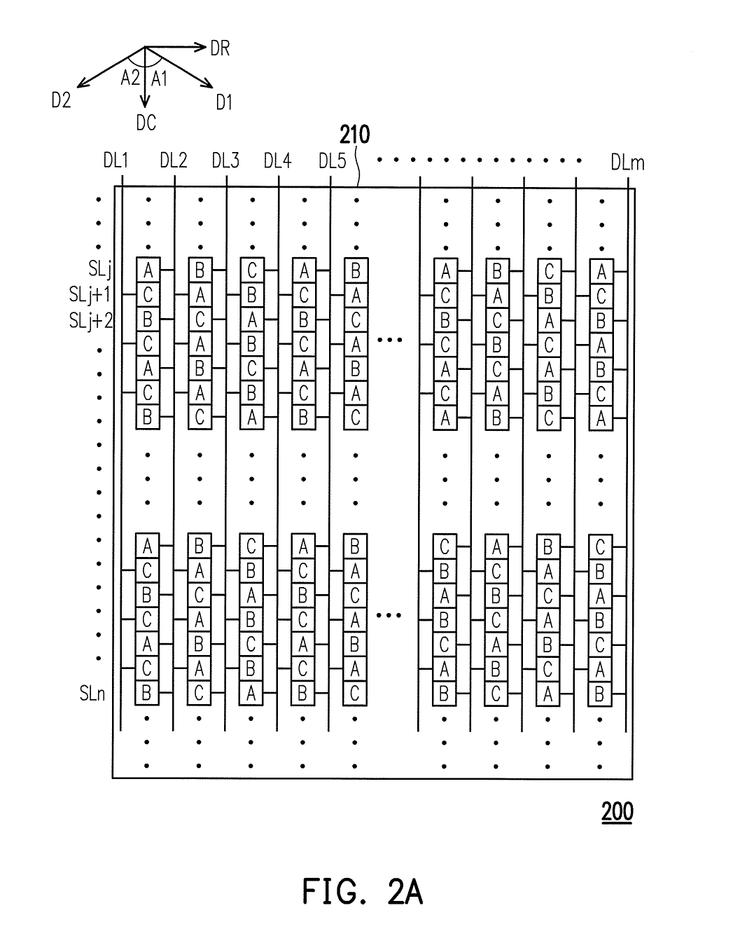

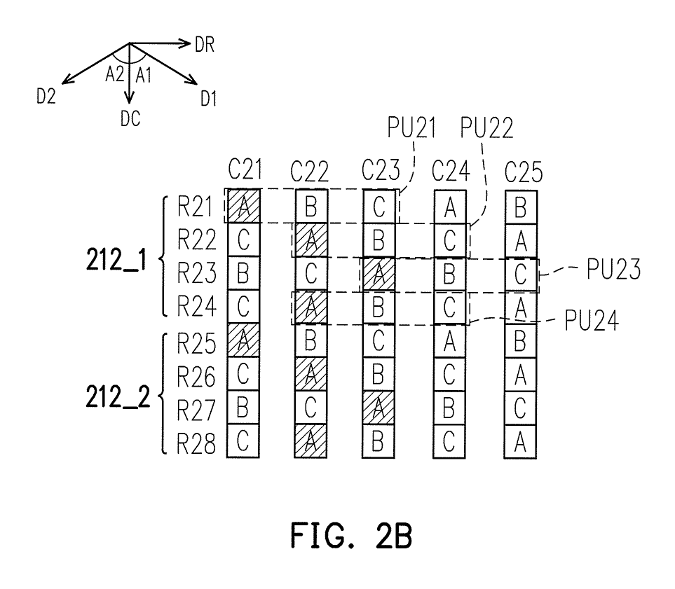

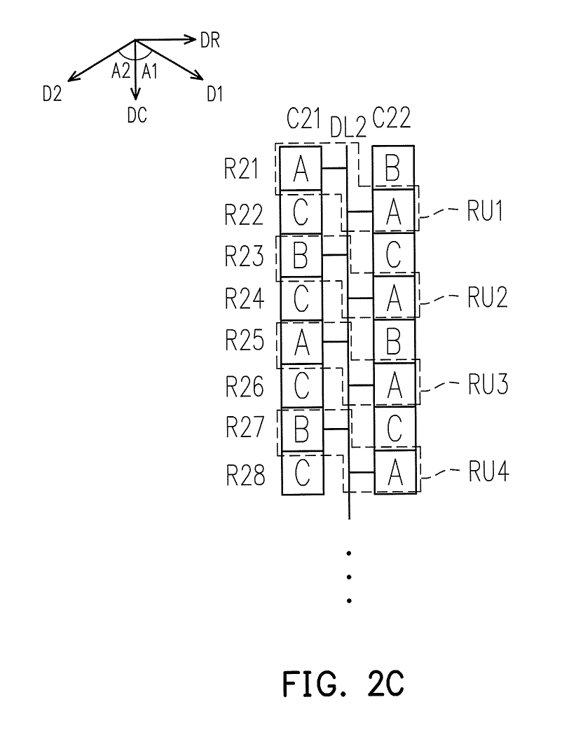

Referring to FIG. 2A at first, a display panel 200 includes a plurality of data lines (notated by DL1 to DLm), a plurality of scan lines (merely notated by SLj, SLj+1, SLj+2 . . . SLn for ease of understanding) and a sub-pixel array 210. The sub-pixel array 210 includes a plurality of pixel units, where the pixel units are arranged along a first direction D1 or along a second direction D2 on the sub-pixel array 210. The first direction D1 is inclined at a first angle A1 relative to a column direction DC of the sub-pixel array 210, and the second direction D2 is inclined at a second angle A2 relative to the column direction DC of the sub-pixel array 210.

In addition, each of the pixel units includes a plurality of sub-pixels, and each of the sub-pixels is coupled to one of the data lines DL1 to DLm and one of the scan lines. The sub-pixels respectively correspond to three different colors, and are adjacently arranged in a row direction DR of the sub-pixel array 210. Specifically, the sub-pixels respectively corresponding to the three colors may be notated by A, B and C respectively. In an embodiment, the sub-pixels A are red sub-pixels, the sub-pixels B are green sub-pixels, and the sub-pixels C are blue sub-pixels. However, the aforementioned notation and its corresponding color may be interchangeable based on design requirements, and the invention is not intended to limit thereto.

In the present embodiment, the sub-pixels corresponding to a same color are not adjacent to each other along the column direction of the sub-pixel array, and the sub-pixels corresponding to the same color are not adjacent to each other along the row direction of the sub-pixel array, wherein the same color is one of the three colors. As illustrated in FIG. 2A, two sub-pixels A arranged in each column of the sub-pixel array 210 are not directly adjacent to each other, and an interval between two adjacent sub-pixels A in each column is at least one sub-pixel size corresponding to the sub-pixel B and/or the sub-pixel C. Besides, two sub-pixels A arranged in each row of the sub-pixel array 210 are not directly adjacent to each other, and an interval between two adjacent sub-pixels A in each row is two times of the sub-pixel size corresponding to the sub-pixel B and the sub-pixel C.

Further, the sub-pixel array 210 may be divided into a plurality of display regions. In the present embodiment, each of the display regions has four rows. In addition, in each of the display regions, a pixel unit in a first row, a pixel unit in a second row and a pixel unit in a third row are arranged along the first direction D1, and the pixel unit in the third row and a pixel unit in a fourth row are arranged along the second direction D2, where the first direction D1 and the second direction D2 are not parallel. Hence, on the display panel 200, the pixel units may be arranged in a zigzag shape along the column direction DC within three columns through the repeating arrangement of the display regions.

Referring to FIG. 2B, two display regions 212_1, 212_2 and four pixel units PU21, PU22, PU23 and PU24 in the display region 212_1 are illustrated for clear explanation. In detail, the display regions 212_1 and 212_2 are arranged adjacently along the column direction DC. In the display regions 212_1, the pixel unit PU21 is located in a row R21, the pixel unit PU22 is located in a row R22, the pixel unit PU23 is located in a row R23, and the pixel unit PU24 is located in a row R24, where each of the pixel units PU21, PU22, PU23 and PU24 may include three sub-pixels A, B and C adjacently arranged along the row direction DR. Moreover, the pixel units PU21, PU22 and PU23 may be arranged along the first direction D1, and the pixel units PU23 and PU24 may be arranged along the second direction D2. Besides, an arrangement of another four pixel units respectively in rows R25 to R28 corresponding to the display region 212_2 may be similar to the arrangement of the pixel units PU21, PU22, PU23 and PU24 in the display region 212_1. Therefore, the pixel units may be arranged in a zigzag shape along the column direction DC on the sub-pixel array 210, and the sub-pixels corresponding to a same color (e.g. the marked sub-pixels A) may be arranged in the zigzag shape along the column direction DC accordingly.

It is worth mentioning that, from another perspective, the display panel 200 may include a plurality of sub-pixel groups repeatedly arranged to form the sub-pixel array 210, where each of the sub-pixel groups may be a 4×3 array (e.g. 12 sub-pixels located within the columns C21 to C23 and the rows R21 to R24). Specifically, in each of the sub-pixel groups, three sub-pixels A, B and C are arranged sequentially along the row direction in a first row, three sub-pixels C, A and B are arranged sequentially along the row direction in a second row, three sub-pixels B, C and A are arranged sequentially along the row direction in a third row, and three sub-pixels C, A and B are arranged sequentially along the row direction in a fourth row.

On the other hand, each of the data lines DL1 to DLm is coupled to a first sub-pixel unit at a side of the each of the data lines DL1 to DLm along the column direction DC of the sub-pixel array 210, and is coupled to a second sub-pixel unit at another side of the each of the data lines DL1 to DLm along the column direction DC of the sub-pixel array 210, where the first sub-pixel unit includes at least one first sub-pixel, the second sub-pixel unit includes at least one second sub-pixel, and the first sub-pixel unit and the second sub-pixel unit are located in different rows. In addition, each of the data lines DL1 to DLm may be coupled a plurality of repeat units, the repeat units are repeatedly arranged along the column direction DC, and each of the repeat units includes the first sub-pixel unit and the second sub-pixel unit.

In the present embodiment, the first sub-pixel unit includes one first sub-pixel, and the second sub-pixel unit includes one second sub-pixel. Moreover, the one first sub-pixel may correspond to two of the three colors, and the one second sub-pixel may correspond to one of the corresponding two colors of the one first sub-pixel.

Referring to FIG. 2C, a data line DL2 and sub-pixels adjacently arranged to the data line DL2 in an 8×2 array according to the embodiment of FIG. 2A are illustrated for detailed explanation. It should be noted that the arrangement of the data line DL2 disclosed by FIG. 2C may be applied for each of the data lines DL1 to DLm.

In the present embodiment, the sub-pixels in a column C21 may be located at a first side of the data line DL2 (e.g. a left-hand side of the data line DL2 as illustrated in FIG. 2C), and the sub-pixels in a column C22 may be located at a second side of the data line DL2 (e.g. a right-hand side of the data line DL2 as illustrated in FIG. 2C). In the column C21, a sub-pixel A in a row R21, a sub-pixel B in a row R23, a sub-pixel A in a row R25 and a sub-pixel B in a row R27 are coupled to the data line DL2. Besides, in the column C22, a sub-pixel A in a row R22, a sub-pixel A in a row R24, a sub-pixel A in a row R26 and a sub-pixel A in a row R28 are coupled to the data line DL2.

Moreover, four repeat units RU1, RU2, RU3 and RU4 arranged along the column direction DC are illustrated in FIG. 2C, and each of the repeat units RU1, RU2, RU3 and RU4 may include one first sub-pixel (i.e. the first sub-pixel unit) at the first side of the data line DL2 and one second sub-pixel (i.e. the second sub-pixel unit) at the second side of the data line DL2. In detail, the repeat unit RU1 may include the sub-pixel A in the row R21 and the column C21 (i.e. the first sub-pixel) and the sub-pixel A in the row R22 and the column C22 (i.e. the second sub-pixel). Similarly, the repeat unit RU2 may include the sub-pixel B in the row R23 and the column C21 (i.e. the first sub-pixel) and the sub-pixel A in the row R24 and the column C22 (i.e. the second sub-pixel), the repeat unit RU3 may include the sub-pixel A in the row R25 and the column C21 (i.e. the first sub-pixel) and the sub-pixel A in the row R26 and the column C22 (i.e. the second sub-pixel), and the repeat unit RU4 may include the sub-pixel B in the row R27 and the column C21 (i.e. the first sub-pixel) and the sub-pixel A in the row R28 and the column C22 (i.e. the second sub-pixel).

Besides, it is worth mentioning that the data line DL2 may be coupled to the sub-pixels in the column C21 and the sub-pixels in the column C22 alternatively in a zigzag shape, where an interval between two adjacent repeat units along the column direction DC at the first side of the data line DL2 is the sub-pixel size, and an interval between two adjacent repeat units along the column direction DC at the second side of the data line DL2 is also the sub-pixel size.

It should be also noted that, in the present embodiment, the sub-pixels located in the column C21 and coupled to the data line DL2 may correspond to two colors of sub-pixels A and B, while the sub-pixels located in the column C22 and coupled to the data line DL2 may correspond to the color of sub-pixels A.

Based on the arrangements of the sub-pixel array 210 and the data lines DL1 to DLm disclosed by FIG. 2A to FIG. 2C, each of the data lines DL1 to DLm may be only coupled to the sub-pixels corresponding to two of the three colors. For instance, as illustrated in FIG. 2A, the data line DL2 (i.e. data lines DL(3i−1), where i is a positive integer) may be only coupled to the sub-pixels corresponding to the color of sub-pixels A and B, the data line DL3 (i.e. data lines DL(3i)) may be only coupled to the sub-pixels corresponding to the color of sub-pixels B and C, and the data line DL4 (i.e. data lines DL(3i−2)) may be only coupled to the sub-pixels corresponding to the color of sub-pixels A and C.

As a result, when a full-screen image frame with a solid color (e.g. red, green or blue) may be displayed by the display panel 200, one data line in every three data lines may not need to be turned on. For instance, Referring to FIG. 2A, when the full-screen image frame with a color corresponding to the color corresponding to sub-pixel A, the data lines DL(3i), such as the data lines DL3, DL6, . . . , may not be turned on. In addition, since the sub-pixels A are only coupled to the data lines DL(3i−2) and DL(3i−1), such as the data lines DL1, DL2, DL4, DL5 . . . , a frequency of the toggling voltage transmitted on each of the data lines, in particular, on each of the data lines DL(3i−2) and DL(3i−1) for display the color corresponding to sub-pixel A, may be decreased. Accordingly, the power consumption may be effectively reduced, and good display effects may be still achieved according to the arrangement of the sub-pixels by using the SPR technology.

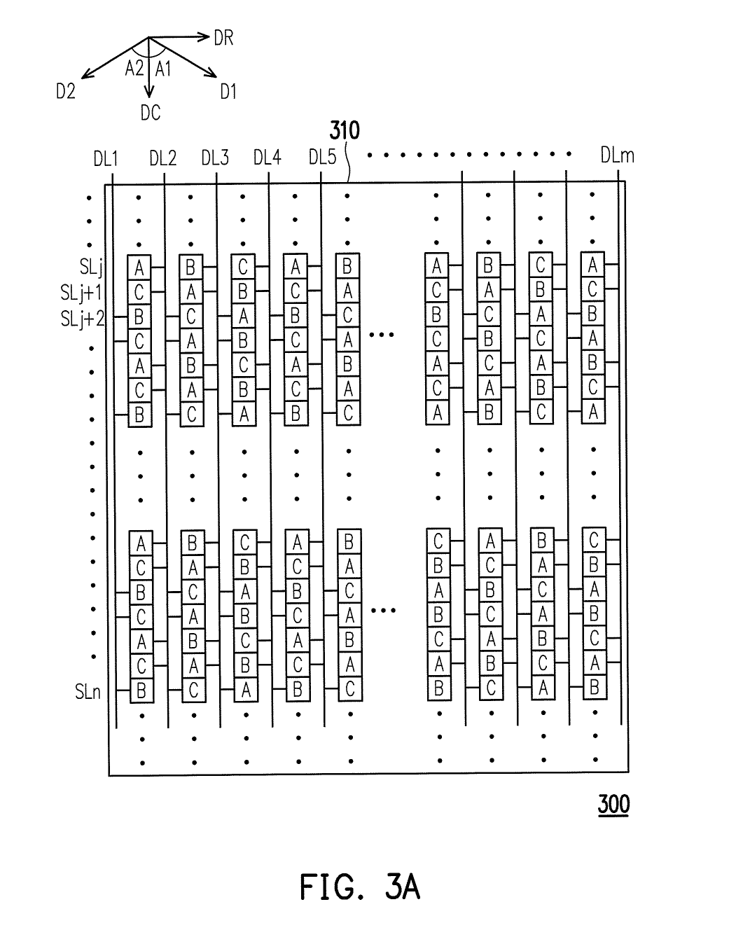

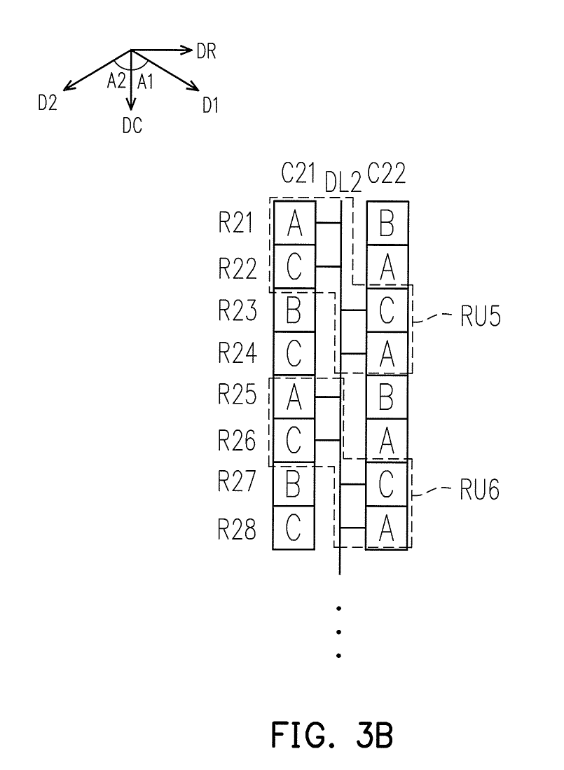

Referring to FIG. 3A at first, a display panel 300 includes a plurality of data lines (notated by DL1 to DLm), a plurality of scan lines (merely notated by SLj, SLj+1, SLj+2 . . . SLn for ease of understanding) and a sub-pixel array 310. The embodiment of FIG. 3A is similar to the aforementioned embodiments, particularly, an arrangement of the sub-pixel array 310 in the present embodiment may be the same as the arrangement of the sub-pixel array 210 in the aforementioned embodiment of FIG. 2A, so similarities are not mentioned here.

In the present embodiment, each of the data lines DL1 to DLm is coupled to two first sub-pixels (i.e. the first sub-pixel unit) at a side of the each of the data lines DL1 to DLm along the column direction DC of the sub-pixel array 310, and is coupled to two second sub-pixels (i.e. the second sub-pixel unit) at another side of the each of the data lines DL1 to DLm along the column direction DC of the sub-pixel array 310, where all of the two first sub-pixels and the two second sub-pixels are located in different rows. Further, each of the data lines DL1 to DLm is coupled to a plurality of repeat units, the repeat units are repeatedly arranged along the column direction DC, and each of the repeat units includes the two first sub-pixels (i.e. the first sub-pixel unit) and the two second sub-pixels (i.e. the second sub-pixel unit). Besides, the two first sub-pixels may respectively correspond to two different colors of the three colors, and the two second sub-pixels may respectively correspond to the corresponding two different colors of the two first sub-pixels.

Referring to FIG. 3B, a data line DL2 and sub-pixels adjacently arranged to the data line DL2 in an 8×2 array according to the embodiment of FIG. 3A are illustrated for detailed explanation. It should be noted that the arrangement of the data line DL2 disclosed by FIG. 3B may be applied for each of the data lines DL1 to DLm.

In the present embodiment, the sub-pixels in a column C21 may be located at a first side of the data line DL2 (e.g. a left-hand side of the data line DL2 as illustrated in FIG. 3B), and the sub-pixels in a column C22 may be located at a second side of the data line DL2 (e.g. a right-hand side of the data line DL2 as illustrated in FIG. 3B). In the column C21, a sub-pixel A in a row R21, a sub-pixel C in a row R22, a sub-pixel A in a row R25 and a sub-pixel C in a row R26 are coupled to the data line DL2. Besides, in the column C22, a sub-pixel C in a row R23, a sub-pixel A in a row R24, a sub-pixel C in a row R27 and a sub-pixel A in a row R28 are coupled to the data line DL2.

Moreover, two repeat units RU5 and RU6 arranged along the column direction DC are illustrated in FIG. 3B, and each of the repeat units RU5 and RU6 may include two first sub-pixels (i.e. the first sub-pixel unit) at the first side of the data line DL2 and two second sub-pixels (i.e. the second sub-pixel unit) at the second side of the data line DL2. In detail, the repeat unit RU5 may include the sub-pixel A in the row R21 and the column C21 (i.e. the first sub-pixel), the sub-pixel C in the row R22 and the column C21 (i.e. the first sub-pixel), the sub-pixel C in the row R23 and the column C22 (i.e. the second sub-pixel) and the sub-pixel A in the row R24 and the column C22 (i.e. the second sub-pixel). Similarly, the repeat unit RU6 may include the sub-pixel A in the row R25 and the column C21 (i.e. the first sub-pixel), the sub-pixel C in the row R26 and the column C21 (i.e. the first sub-pixel), the sub-pixel C in the row R27 (i.e. the second sub-pixel) and the column C22 and the sub-pixel A in the row R28 and the column C22 (i.e. the second sub-pixel).

Besides, it is worth mentioning that the data line DL2 may be coupled to the sub-pixels in the column C21 and the sub-pixels in the column C22 alternatively in a zigzag shape, where an interval between two adjacent repeat units along the column direction DC at the first side of the data line DL2 is two times of the sub-pixel size, and an interval between two adjacent repeat units along the column direction DC at the second side of the data line DL2 is also two times of the sub-pixel size.

It should be also noted that, in the present embodiment, the sub-pixels located in the column C21 and coupled to the data line DL2 may correspond to two colors of sub-pixels A and C, and the sub-pixels located in the column C22 and coupled to the data line DL2 may also correspond to the two colors of sub-pixels A and C.

Based on the arrangements of the sub-pixel array 310 and the data lines DL1 to DLm disclosed by FIG. 3A and FIG. 3B, each of the data lines DL1 to DLm may be only coupled to the sub-pixels corresponding to two of the three colors. For instance, as illustrated in FIG. 3A, when the full-screen image frame with a color corresponding to the color corresponding to sub-pixel A, the data lines DL(3i−2) may not be turned on. In addition, since the sub-pixels A are only coupled to the data lines DL(3i−1) and DL(3i), a frequency of the toggling voltage transmitted on each of the data lines, in particular, on each of the data lines DL(3i−1) and DL(3i) for display the color corresponding to sub-pixel A, may be decreased. Accordingly, the power consumption may be effectively reduced, and good display effects may be still achieved according to the arrangement of the sub-pixels by using the SPR technology.

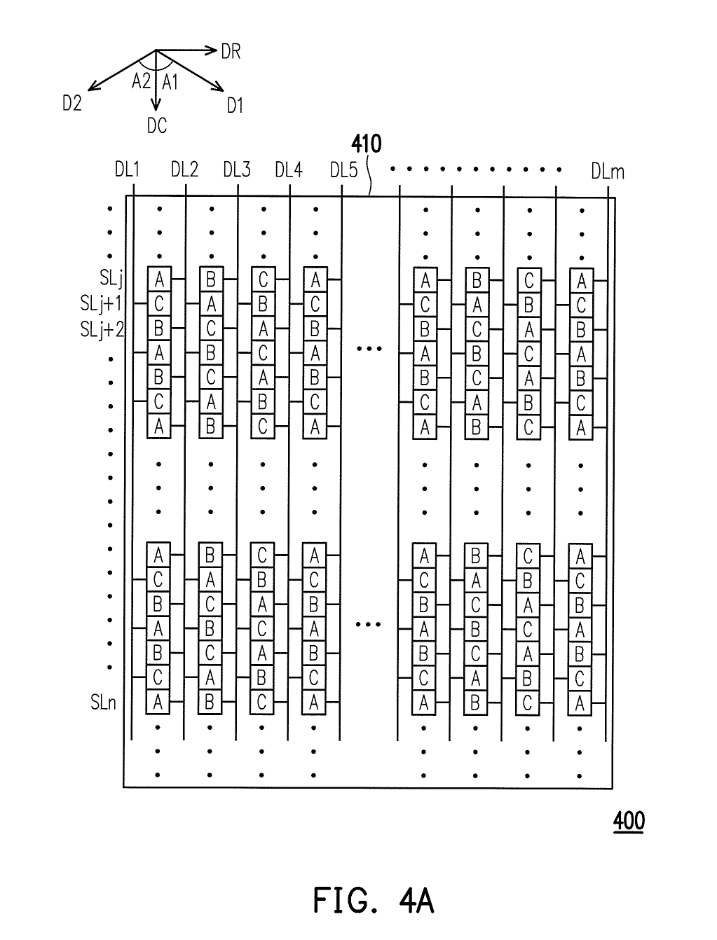

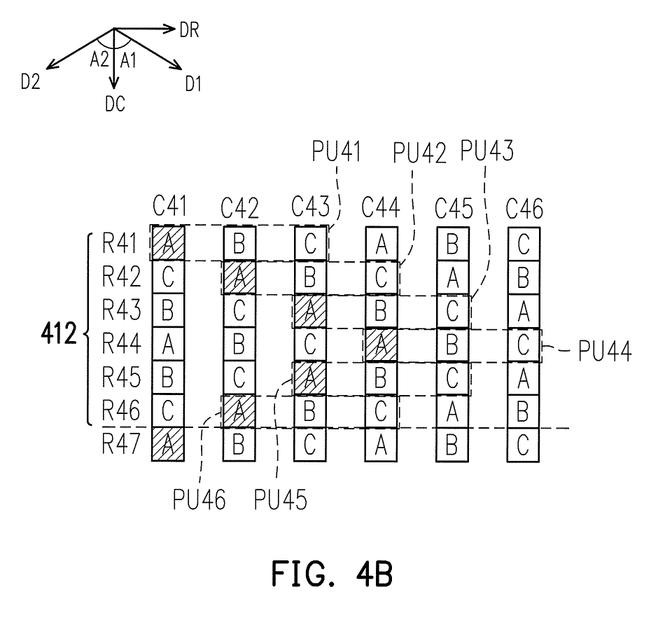

Referring to FIG. 4A at first, a display panel 400 includes a plurality of data lines (notated by DL1 to DLm), a plurality of scan lines (merely notated by SLj, SLj+1, SLj+2 . . . SLn for ease of understanding) and a sub-pixel array 410. The embodiment of FIG. 4A is similar to the aforementioned embodiments, particularly, arrangements of the data lines DL1 to DLm in the present embodiment may be the same as the arrangements of the data lines DL1 to DLm in the aforementioned embodiment of FIG. 2A, so similarities are not mentioned here.

In the present embodiment, the sub-pixel array 410 may be divided into a plurality of display regions, where each of the display regions has six rows. In addition, in each of the display regions, a pixel unit in a first row, a pixel unit in a second row, a pixel unit in a third row and a pixel unit in a fourth row are arranged along the first direction D1, and the pixel unit in the fourth row, a pixel unit in a fifth row and a pixel unit in a sixth row are arranged along the second direction D2, where the first direction D1 and the second direction D2 are not parallel. Hence, on the display panel 400, the pixel units may be arranged in a zigzag shape along the column direction DC within four columns through the repeating arrangement of the display regions.

Referring to FIG. 4B, a display region 412 and six pixel units PU41, PU42, PU43, PU44, PU45 and PU46 in the display region 412 are illustrated for clear explanation. Besides, sub-pixels in a row R47 may be also illustrated in FIG. 4B for ease of understanding, where the sub-pixels in the row R47 may be included in another display region adjacent to the display regions 412 along the column direction DC. In the display regions 412, the pixel unit PU41 is located in a row R41, the pixel unit PU42 is located in a row R42, the pixel unit PU43 is located in a row R43, the pixel unit PU44 is located in a row R44, the pixel unit PU45 is located in a row R45, and the pixel unit PU46 is located in a row R46, where each of the pixel units PU41, PU42, PU43, PU44, PU45 and PU46 may include three sub-pixels A, B and C adjacently arranged along the row direction DR. Moreover, the pixel units PU41, PU42, PU43 and PU44 may be arranged along the first direction D1, and the pixel units PU44, PU45 and PU46 may be arranged along the second direction D2. Besides, arrangements of other display regions may be similar to the arrangement of the display region 412, such that the pixel units may be arranged in a zigzag shape along the column direction DC on the sub-pixel array 410, and the sub-pixels corresponding to a same color (e.g. the marked sub-pixels A) may be arranged in the zigzag shape along the column direction DC accordingly.

It is worth mentioning that, from another perspective, the display panel 400 may include a plurality of sub-pixel groups repeatedly arranged to form the sub-pixel array 410, where each of the sub-pixel groups may be a 6×3 array (e.g. 18 sub-pixels located within the columns C41 to C43 and the rows R41 to R46). Specifically, in each of the sub-pixel groups, three sub-pixels A, B and C are arranged sequentially along the row direction in a first row, three sub-pixels C, A and B are arranged sequentially along the row direction in a second row, three sub-pixels B, C and A are arranged sequentially along the row direction in a third row, three sub-pixels A, B and C are arranged sequentially along the row direction in a fourth row, three sub-pixels B, C and A are arranged sequentially along the row direction in a fifth row, and three sub-pixels C, A and B are arranged sequentially along the row direction in a sixth row.

It should be also noted that, in the present embodiment, the sub-pixels located at a first side of the data line DL2 (e.g. a left-hand side of the data line DL2) and coupled to the data line DL2 may correspond to two colors of sub-pixels A and B, and the sub-pixels located at a second side of the data line DL2 (e.g. a right-hand side of the data line DL2) and coupled to the data line DL2 may also correspond to the color of sub-pixels A and B. Similarly, the sub-pixels located at both sides of the data line DL3 and coupled to the data line DL3 may correspond to two colors of sub-pixels B and C, and the sub-pixels located at both sides of the data line DL4 and coupled to the data line DL4 may correspond to two colors of sub-pixels A and C. Therefore, based on the arrangements of the sub-pixel array 410 and the data lines DL1 to DLm disclosed by FIG. 4A and FIG. 4B, each of the data lines DL1 to DLm may be only coupled to the sub-pixels corresponding to two of the three colors. For instance, as illustrated in FIG. 4A, when the full-screen image frame with a color corresponding to the color corresponding to sub-pixel A, the data lines DL(3i) may not be turned on. In addition, since the sub-pixels A are only coupled to the data lines DL(3i−2) and DL(3i−1), a frequency of the toggling voltage transmitted on each of the data lines, in particular, on each of the data lines DL(3i−2) and DL(3i−1) for display the color corresponding to sub-pixel A, may be decreased. Accordingly, the power consumption may be effectively reduced, and good display effects may be still achieved according to the arrangement of the sub-pixels by using the SPR technology.

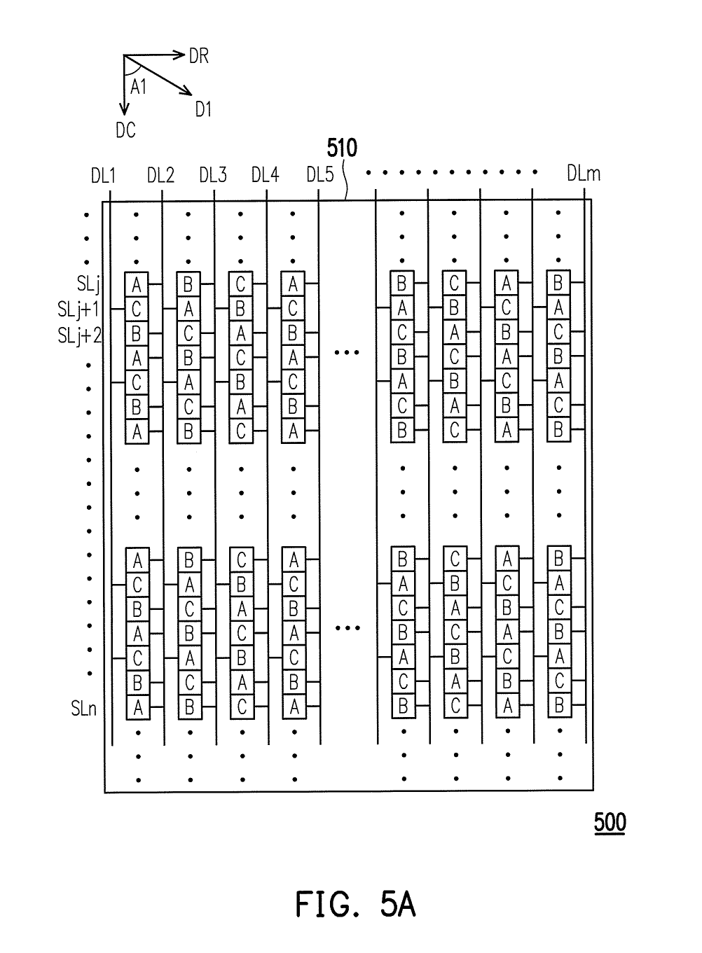

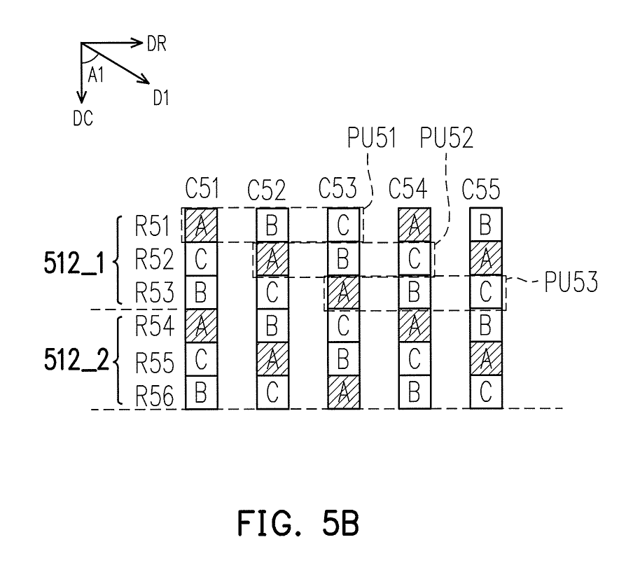

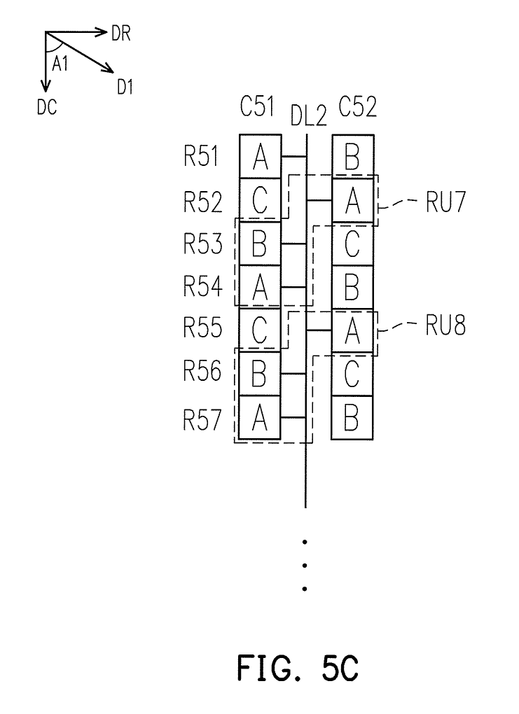

Referring to FIG. 5A at first, a display panel 500 includes a plurality of data lines (notated by DL1 to DLm), a plurality of scan lines (merely notated by SLj, SLj+1, SLj+2 . . . SLn for ease of understanding) and a sub-pixel array 510. The embodiment of FIG. 5A is similar to the aforementioned embodiments, so similarities are not mentioned here.

In the present embodiment, the sub-pixel array 510 may be divided into a plurality of display regions, where each of the display regions has three rows. In addition, in each of the display regions, a pixel unit in a first row, a pixel unit in a second row and a pixel unit in a third row are arranged along the first direction D1.

Referring to FIG. 5B, two display regions 512_1, 512_2 and three pixel units PU51, PU52 and PU53 are illustrated for clear explanation. In the display regions 512_1, the pixel unit PU51 is located in a row R51, the pixel unit PU52 is located in a row R52, and the pixel unit PU53 is located in a row R53. Besides, arrangements of other display regions (e.g. the display region 512_2) may be similar to the arrangement of the display region 512_1, such that the pixel units may be arranged along the first direction D1 on the sub-pixel array 510, and the sub-pixels corresponding to a same color (e.g. the marked sub-pixels A) may be also arranged along the first direction D1 accordingly.

It is worth mentioning that, from another perspective, the display panel 500 may include a plurality of sub-pixel groups repeatedly arranged to form the sub-pixel array 510, where each of the sub-pixel groups may be a 3×3 array (e.g. 9 sub-pixels located within the columns C51 to C53 and the rows R51 to R53). Specifically, in each of the sub-pixel groups, three sub-pixels A, B and C are arranged sequentially along the row direction in a first row, three sub-pixels C, A and B are arranged sequentially along the row direction in a second row, and three sub-pixels B, C and A are arranged sequentially along the row direction in a third row.

On the other hand, in the present embodiment, each of the data lines DL1 to DLm is coupled to two first sub-pixels (i.e. the first sub-pixel unit) at a side of the each of the data lines DL1 to DLm along the column direction DC of the sub-pixel array 510, and is coupled to one second sub-pixel (i.e. the second sub-pixel unit) at another side of the each of the data lines DL1 to DLm along the column direction DC of the sub-pixel array 510, where all of the two first sub-pixels and the one second sub-pixels are located in different rows. Further, each of the data lines DL1 to DLm is coupled a plurality of repeat units, the repeat units are repeatedly arranged along the column direction DC, and each of the repeat units includes the two first sub-pixels and the one second sub-pixel in the present embodiment. Besides, the two first sub-pixels may respectively correspond to two different colors of the three colors, and the one second sub-pixel may correspond to one of the corresponding two colors of the one first sub-pixel.

Referring to FIG. 5C, a data line DL2 and sub-pixels adjacently arranged to the data line DL2 in a 7×2 array according to the embodiment of FIG. 5A are illustrated for detailed explanation. It should be noted that the arrangement of the data line DL2 disclosed by FIG. 5C may be applied for each of the data lines DL1 to DLm.

In the present embodiment, the sub-pixels in a column C51 may be located at a first side of the data line DL2 (e.g. a left-hand side of the data line DL2 as illustrated in FIG. 5C), and the sub-pixels in a column C52 may be located at a second side of the data line DL2 (e.g. a right-hand side of the data line DL2 as illustrated in FIG. 5C). In the column C51, a sub-pixel B in a row R53, a sub-pixel A in a row R54, a sub-pixel B in a row R56 and a sub-pixel A in a row R57 are coupled to the data line DL2. Besides, in the column C52, a sub-pixel A in a row R52, and a sub-pixel A in a row R55 are coupled to the data line DL2.

Moreover, two repeat units RU7 and RU8 arranged along the column direction DC are illustrated in FIG. 5C, and each of the repeat units RU7 and RU8 may include two first sub-pixels (i.e. the first sub-pixel unit) at the first side of the data line DL2 and one second sub-pixel (i.e. the second sub-pixel unit) at the second side of the data line DL2. In detail, the repeat unit RU7 may include the sub-pixel B in the row R53 and the column C51 (i.e. the first sub-pixel), the sub-pixel A in the row R54 and the column C51 (i.e. the first sub-pixel) and the sub-pixel A in the row R52 and the column C52 (i.e. the second sub-pixel). Similarly, the repeat unit RU8 may include the sub-pixel B in the row R56 and the column C51 (i.e. the first sub-pixel), the sub-pixel A in the row R57 and the column C51 (i.e. the first sub-pixel) and the sub-pixel A in the row R55 and the column C52 (i.e. the second sub-pixel).

Besides, it is worth mentioning that the data line DL2 may be coupled to the sub-pixels in the column C51 and the sub-pixels in the column C52 alternatively in a zigzag shape, where an interval between two adjacent repeat units along the column direction DC at the first side of the data line DL2 is two times of the sub-pixel size, and an interval between two adjacent repeat units along the column direction DC at the second side of the data line DL2 is the sub-pixel size.

It should be also noted that, in the present embodiment, the sub-pixels located in the column C51 and coupled to the data line DL2 may correspond to two colors of sub-pixels A and B, while the sub-pixels located in the column C52 and coupled to the data line DL2 may correspond to the color of sub-pixel A.

Based on the arrangements of the sub-pixel array 510 and the data lines DL1 to DLm disclosed by FIG. 5A to FIG. 5C, each of the data lines DL1 to DLm may be only coupled to the sub-pixels corresponding to two of the three colors. For instance, as illustrated in FIG. 5A, when the full-screen image frame with a color corresponding to the color corresponding to sub-pixel A, the data lines DL(3i) may not be turned on. In addition, since the sub-pixels A are only coupled to the data lines DL(3i−2) and DL(3i−1), a frequency of the toggling voltage transmitted on each of the data lines, in particular, on each of the data lines DL(3i−2) and DL(3i−1) for display the color corresponding to sub-pixel A, may be decreased. Accordingly, the power consumption may be effectively reduced, and good display effects may be still achieved according to the arrangement of the sub-pixels by using the SPR technology.

It is worthy mentioning that, in other embodiments, the sub-pixels may correspond to more than three colors, which may be adaptively adjusted based on design requirements. Taking the sub-pixels corresponding to four colors for example, in an embodiment, the sub-pixels may include red sub-pixels, green sub-pixels, blue sub-pixels and white sub-pixels, while in another embodiment, the sub-pixels may include red sub-pixels, first green sub-pixels, blue sub-pixels and second green sub-pixels.

To conclude the above, the display panel according to the embodiments of the invention may provide multiple arrangements of the sub-pixels and the data lines respectively, which may adaptively arrange the sub-pixels corresponding to a same color to be coupled to only a portion of the data lines. Therefore, high resolution and good display quality may be achieved based on the arrangement of the sub-pixels by using the SPR technology. In addition, through adjusting the arrangements of the data lines to be consistent with the arrangements of the sub-pixels, the frequency of the toggling voltage transmitted on each of the data lines may be further decreased. Therefore, power consumption may be effectively reduced and good display quality may be also achieved.

What is claimed is:

1. A display panel comprising:
a plurality of data lines; and
a sub-pixel array, comprising a plurality of pixel units, wherein the pixel units are arranged along a first direction or along a second direction, the first direction is inclined at a first angle relative to a column direction of the sub-pixel array, and the second direction is inclined at a second angle relative to the column direction of the sub-pixel array,
wherein each of the pixel units comprises a plurality of sub-pixels, and the sub-pixels respectively correspond to three different colors and are adjacently arranged in a row direction of the sub-pixel array,
wherein each of the data lines is coupled to a first sub-pixel unit at a side of the each of the data lines along the column direction of the sub-pixel array, and is coupled to a second sub-pixel unit at another side of the each of the data lines along the column direction of the sub-pixel array, the first sub-pixel unit comprises at least one first sub-pixel, the second sub-pixel unit comprises at least one second sub-pixel, and the first sub-pixel unit and the second sub-pixel unit are located in different rows.

2. The display panel according to claim 1, wherein each of the data lines is coupled a plurality of repeat units, the repeat units are repeatedly arranged along the column direction, and each of the repeat units comprises the first sub-pixel unit and the second sub-pixel unit.

3. The display panel according to claim 1, wherein the at least one first sub-pixel corresponds to two of the three colors, and the at least one second sub-pixel corresponds to at least one of the corresponding two colors of the at least one first sub-pixel.

4. The display panel according to claim 3, wherein the first sub-pixel unit comprises one first sub-pixel, and the second sub-pixel unit comprises one second sub-pixel.

5. The display panel according to claim 4, wherein the one first sub-pixel corresponds to two of the three colors along the column direction, and the one second sub-pixel corresponds to one of the corresponding two colors of the one first sub-pixel.

6. The display panel according to claim 5, wherein the sub-pixel array is divided into a plurality of display regions, and each of the display regions has four rows,
wherein in each of the display regions, a pixel unit in a first row, a pixel unit in a second row and a pixel unit in a third row are arranged along the first direction, and the pixel unit in the third row in the display region and a pixel unit in a fourth row of the display region are arranged along the second direction.

7. The display panel according to claim 4, wherein the one first sub-pixel corresponds to two of the three colors along the column direction, and the one second sub-pixel corresponds to the corresponding two colors of the one first sub-pixel.

8. The display panel according to claim 7, wherein the sub-pixel array is divided into a plurality of display regions, and each of the display regions has six rows,
wherein in each of the display regions, a pixel unit in a first row, a pixel unit in a second row, a pixel unit in a third row and a pixel unit in a fourth row are arranged along the first direction, and the pixel unit in the fourth row, a pixel unit in a fifth row and a pixel unit in the sixth row are arranged along the second direction.

9. The display panel according to claim 3, wherein the first sub-pixel unit comprises two first sub-pixels, and the second sub-pixel unit comprises two second sub-pixels.

10. The display panel according to claim 9, wherein the two first sub-pixels respectively correspond to two different colors of the three colors, and the two second sub-pixels respectively correspond to the corresponding two different colors of the two first sub-pixels.

11. The display panel according to claim 10, wherein the sub-pixel array is divided into a plurality of display regions, and each of the display regions has four rows,
wherein in each of the display regions, a pixel unit in a first row, a pixel unit in a second row and a pixel unit in a third row are arranged along the first direction, and the pixel unit in the third row and a pixel unit in a fourth row are arranged along the second direction.

12. The display panel according to claim 3, wherein the first sub-pixel unit comprises two first sub-pixels, and the second sub-pixel unit comprises one second sub-pixel.

13. The display panel according to claim 12, wherein the two first sub-pixels respectively correspond to two different colors of the three colors, and the one second sub-pixel corresponds to one of the corresponding two colors of the one first sub-pixel.

14. The display panel according to claim 13, wherein the sub-pixel array is divided into a plurality of display regions, and each of the display regions has three rows,
wherein in each of the display regions, a pixel unit in a first row, a pixel unit in a second row and a pixel unit in a third row are arranged along the first direction.

15. The according to claim 1, wherein sub-pixels corresponding to a same color are not adjacent to each other along the column direction of the sub-pixel array, and the sub-pixels corresponding to the same color are not adjacent to each other along the row direction of the sub-pixel array, wherein the same color is one of the three colors.

16. The according to claim 1, wherein the first direction and the second direction are not parallel.

17. The according to claim 1, wherein the sub-pixels are red sub-pixels, green sub-pixels and blue sub-pixels.
